(19) United States
(12) Patent Application Publication
(10) Pub. No.: US 2022/0364376 A1
(43) Pub. Date: Nov. 17, 2022

(54) Self-climbing platform and method

(71) Applicant: Luc Bouchard, Dolbeau-Mistassini (CA)

(72) Inventor: Luc Bouchard, Dolbeau-Mistassini (CA)

(21) Appl. No.: 17/813,787

(22) Filed: Jul. 20, 2022

Related U.S. Application Data
(63) Continuation-in-part of application No. 16/526,517, filed on Jul. 30, 2019.

(51) Int. Cl. E04G 3/32; B66F 11/04

(52) U.S. Cl. CPC E04G 3/32; B66F 11/04; E04G 2003/286

(57) ABSTRACT

A self-climbing platform adapted to movably attach to, and hang from, a vertical structure for supporting a load with a cable connected to a main support connector comprising a retaining strap configured to surround at least a portion of the vertical structure, an adjustment lock attached to the retaining strap and a bracket. The bracket comprising an upper member connecting on one side to an adjustment bar and to a second side of a lower member to form a triangulated structure configured to a cantilevered position with respect to the vertical structure. The cable supporting the platform is connected to the bracket in a manner permitting transmission of the force required to support the self-climbing platform in a direction angled towards the vertical structure. The platform can rotate 360° around a tree or pole and can be used in forestry, civil or recreational fields.

### CROSS-REFERENCE TO RELATED APPLICATIONS

The present patent application is a continuation-in-part of U.S. patent application Ser. No. 16/536,517, entitled “SELF-CLIMBING PLATFORM”, and filed at the United States Patent Office on Jul. 30, 2019, the content of which is incorporated herein by reference.

### FIELD OF THE INVENTION

The present invention essentially relates to the field of transportable and removable platforms for mounting on trees or poles for use in the civil industry, forestry or recreation among others and to method for moving such platforms along a vertical structure. Specifically, the present invention relates to a platform which may be alternatively secured to move up and down a vertical structure such as a tree or a pole and which may support at least one user.

### BACKGROUND OF THE INVENTION

The use of tree platforms is known in the art. More specifically, tree platforms are typically utilized for hunting purposes and generally consist familiar, expected and obvious structural configurations, notwithstanding the myriad of designs encompassed by the crowded prior art which have been developed for the fulfillment of countless objectives and requirements.

By way of example, U.S. Pat. No. 5,803,694 discloses a wheeled platform adapted to be secured to a tree and lifted using a winch engaging a cable wrapped about an upper end of the tree.

However, all of the tree platforms disclosed in the prior art require that a user first climb the tree to secure a cable at an elevated position defining an upper limit to the attainable height of the platform. Reaching this elevated position poses challenges which can be dangerous or fatal for the user.

There is thus a need for a novel platform and method allowing self-climbing along a vertical structure overcoming the drawbacks or shortcomings of the platforms of the prior art.

### SUMMARY OF THE INVENTION

The shortcomings of the prior art are generally mitigated by a self-climbing platform adapted to movably attach to a substantially cylindrical and vertical structure, the self-climbing platform comprising a platform forming a surface for supporting a load, the platform being adapted to hang from the vertical structure above ground, an upper locking support comprising a retaining member configured to surround at least an outer portion of the vertical structure and to frictionally engage with the outer portion of the vertical structure, a bracket configured to receive first and second ends of the retaining member and a first locking mechanism for selectively tensioning and releasing tension in the retaining member to the vertical structure, wherein the upper locking support selectively restricts downward movement of the platform along the structure and is movable vertically when tension is released on the upper locking support, a lower self-locking support system suspended to the upper locking support, the lower self-locking support automatically supporting the vertical load of the platform and restricting downward movement of the platform along the structure while allowing an upward movement along the structure.

According to an aspect of the invention, the main support may be suspended from the bracket by a cable, wherein the cable is connected to the bracket by a bearing element, and wherein the platform further comprises a winch connected to the cable, the winch being adapted to lift and descend the platform when the upper locking support is engaged with the vertical structure. The platform may further comprise a safety railing, a seat and at least one sliding system to slide along the vertical structure, wherein the sliding system is configured to slide around the vertical structure and allow rotation of the platform around the vertical structure while suspended.

According to another aspect of the invention, the lower self-locking locking support system may comprise a lever for temporarily disengaging the lower self-locking locking mechanism, wherein the lever is biased by a resilient member to maintain the lower self-locking support system against the structure, the resilient member being a spring. The upper locking support may comprise a quick release lever.

The shortcomings of the prior art are further mitigated by a method of vertically moving a platform about a substantially cylindrical and vertical structure comprising continuously restricting a downward movement of the platform along the vertical structure, securing an upper locking support to the vertical structure above the platform at a first location and lifting the vertical structure while the downward movement of the platform is continuously restricted.

According to an aspect of the invention, the method may further comprise releasing tension on the upper locking support while the downward movement of the platform is continuously restricted and securing the upper locking support to the vertical structure at a second location above the first location and ascending the vertical structure near the second location. The method may further comprise using a release lever of a self-locking support mechanism to release tension of the self-locking support mechanism while the upper locking support is secured, wherein securing the upper locking support comprises engaging a quick release lever and wherein ascending the vertical structure comprises actuating a motorized lifting device.

The shortcomings of the prior art are still further mitigated by a method of vertically descending a platform about a substantially cylindrical and vertical structure comprising securing an upper locking support to the vertical structure above the platform at a first location, releasing a self-locking support mechanism adapted to restrict a downward movement of the platform along the vertical structure and descending the vertical structure while the downward movement of the platform is continuously unrestricted.

According to an aspect of the invention, the method may further comprise actuating a motorized lifting device to tension a suspending device prior to releasing the self-locking support mechanism. The method may further comprise reengaging the self-locking support mechanism, releasing the upper locking support from the vertical structure and repositioning the upper locking support at a second location being lower than the first location, wherein releasing the self-locking support mechanism comprises engaging a release lever of the self-locking support mechanism.

In another aspect of the present invention, a self-climbing platform adapted to movably attach to a substantially cylindrical and vertical structure is provided. The self-climbing platform comprises a platform forming a surface for supporting a load, the platform being adapted to hang from the vertical structure above ground. The self-climbing platform further comprises an upper locking support comprising a retaining member configured to surround at least an outer portion of the vertical structure and to frictionally engage with the outer portion of the vertical structure, a bracket configured to receive first and second ends of the retaining member and a first locking mechanism for selectively tensioning and releasing tension in the retaining member to the vertical structure, wherein the upper locking support selectively restricts downward movement of the platform along the structure and is movable vertically when tension is released on the upper locking support. The self-climbing platform further comprises a lower self-locking support system suspended to the upper locking support, the lower self-locking support automatically supporting the vertical load of the platform and restricting downward movement of the platform along the structure while allowing an upward movement along the structure.

The main support may be suspended from the bracket by a cable. The cable may be connected to the bracket by a bearing element. The platform may further comprise a winch connected to the cable, the winch being adapted to lift and descend the platform when the upper locking support is engaged with the vertical structure.

The platform may comprise at least one sliding system to slide along the vertical structure. The sliding system may be configured to slide around the vertical structure and allow rotation of the platform around the vertical structure while suspended.

The lower self-locking locking support system may comprise a lever for temporarily disengaging the lower self-locking locking mechanism. The lever may be biased by a resilient member to maintain the lower self-locking support system against the structure. The resilient member may be a spring.

The upper locking support may comprise a quick release lever. The self-climbing platform may further comprise a pivoting mechanism adapted to pivot the platform about an axis substantially orthogonal to a longitudinal axis of the vertical structure, the pivoting mechanism comprising a telescopic rod.

In another aspect of the invention, a method of vertically moving a platform about a substantially cylindrical and vertical structure is provided. The method comprises continuously restricting a downward movement of the platform along the vertical structure, securing an upper locking support to the vertical structure above the platform at a first location and lifting the vertical structure while the downward movement of the platform is continuously restricted.

The method may further comprise releasing tension on the upper locking support while the downward movement of the platform is continuously restricted or securing the upper locking support to the vertical structure at a second location above the first location and ascending the vertical structure near the second location.

The lifting the vertical structure may comprise actuating a motorized lifting device.

The method may further comprise using a release lever of a self-locking support mechanism to release tension of the self-locking support mechanism while the upper locking support is secured. Securing the upper locking support may comprise engaging a quick release lever.

In yet another aspect of the invention, a method of vertically descending a platform about a substantially cylindrical and vertical structure is provided. The method comprises securing an upper locking support to the vertical structure above the platform at a first location, releasing a self-locking support mechanism adapted to restrict a downward movement of the platform along the vertical structure and descending the vertical structure while the downward movement of the platform is continuously unrestricted.

The method may further comprise actuating a motorized lifting device to tension a suspending device prior to releasing the self-locking support mechanism.

The method may further comprise reengaging the self-locking support mechanism;

releasing the upper locking support from the vertical structure and repositioning the upper locking support at a second location being lower than the first location.

Releasing the self-locking support mechanism may comprise engaging a release lever of the self-locking support mechanism.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

The above and other aspects, features and advantages of the invention will become more readily apparent from the following description, reference being made to the accompanying drawings in which:

FIG. 1 is an illustration of a perspective view of a self-climbing platform according to an embodiment of the present invention.

FIG. 2 is an illustration of a front view of the self-climbing platform of FIG. 1.

FIG. 3 is an illustration of a side view of the self-climbing platform of FIG. 1.

FIG. 4 is an illustration of a top plan view of the self-climbing platform of FIG. 1.

FIG. 5 is an enlarged illustration of a connector of the self-climbing platform of FIG. 1.

FIG. 6 is an illustration of a front perspective view of a self-climbing platform according to another embodiment of the present invention.

FIG. 7 is an illustration of a top perspective view of the self-climbing platform of FIG. 6.

FIG. 8 is an illustration of a bottom perspective view of the self-climbing platform of FIG. 6.

FIG. 9 is an illustration of a front view of the self-climbing platform of FIG. 6.

FIG. 10 is an illustration of a side view of the self-climbing platform of FIG. 6.

FIG. 11 is a top perspective view of a top supporting mechanism of the self-climbing platform of FIG. 6.

FIG. 12 is a bottom perspective view of the top supporting mechanism of FIG. 11.

FIG. 13 is a front view of the top supporting mechanism of FIG. 11.

FIG. 14 is a side view of the top supporting mechanism of FIG. 11.

### DETAILED DESCRIPTION OF THE INVENTION

A novel self-climbing platform and method will be described hereinafter. Although the invention is described in terms of specific illustrative embodiments, it is to be understood that the embodiments described herein are by way of example only and that the scope of the invention is not intended to be limited thereby.

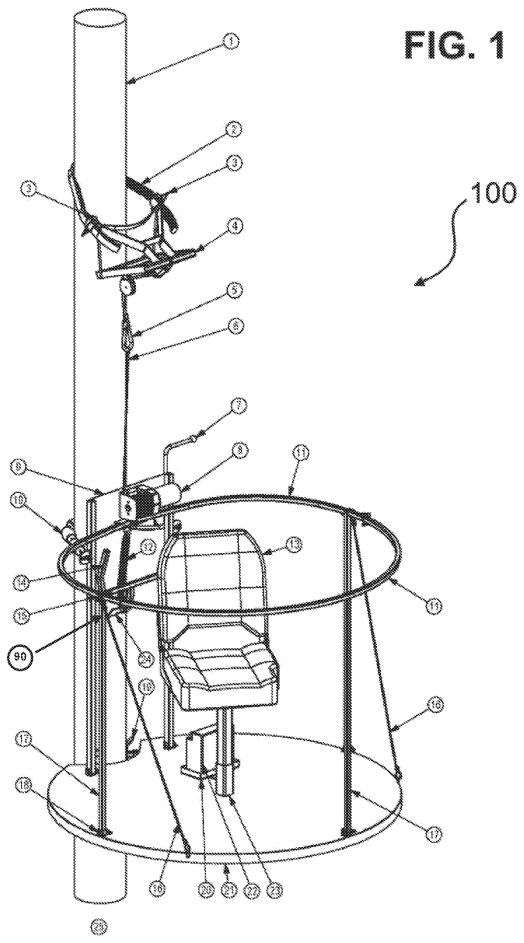

Referring to FIG. 1, in one embodiment, a self-climbing platform 100 is illustrated.

The platform 100 may comprise a frame or main supporting structure 9. The main supporting structure 9 typically includes a lifting mechanism 8 (such as, for example, a winch) connected to a top supporting mechanism 26. The main supporting structure 9 generally comprises a plate connected to a support platform 21 comprising the lower part of the platform 100 through vertical supports. The said plate is typically attached at a top portion of the main supporting structure 9.

The top supporting mechanism 26 is attached to the vertical structure 1 and support the load of the self-climbing platform 100. The self-climbing platform 100 is configured to be supported on a vertical structure 1, such as a tree or a pole. The vertical structure 1 generally has a cylindrical shape. In the illustrated embodiment, the top supporting mechanism 26 typically comprises a 360° removable bracket 4 attachable to the vertical structure 1 at a height higher than the support platform 21.

The self-climbing platform 100 generally allows vertical movement, such as up or down along the vertical structure 1. Still referring to FIG. 1, the self-climbing platform 100 typically further comprises a cable 6 for interconnecting the main supporting structure 9 and the top supporting mechanism 26, as well as one or more sliding mechanisms 110.

The support platform 21 may be grid-bottomed, the lifting mechanism 8 may be attached to the main supporting structure 9. The main supporting structure 9 is generally adapted to slide along the vertical structure 1.

The top supporting mechanism 26, also referred to as a connector 26, is configured to automatically support the load or weight of the support platform 21 when at rest and to slide along the vertical structure 1 when manipulated by a user. As such, the top supporting mechanism 26 may be moved up or down when the platform is supported by the lower supporting mechanism 9. In some embodiments, the top supporting mechanism 26 comprises a bracket 4 connected to an adjustable retaining strap 2 and two adjustment locks 3 to hold the bracket 4 in place at an angle with regard to the vertical structure 1.

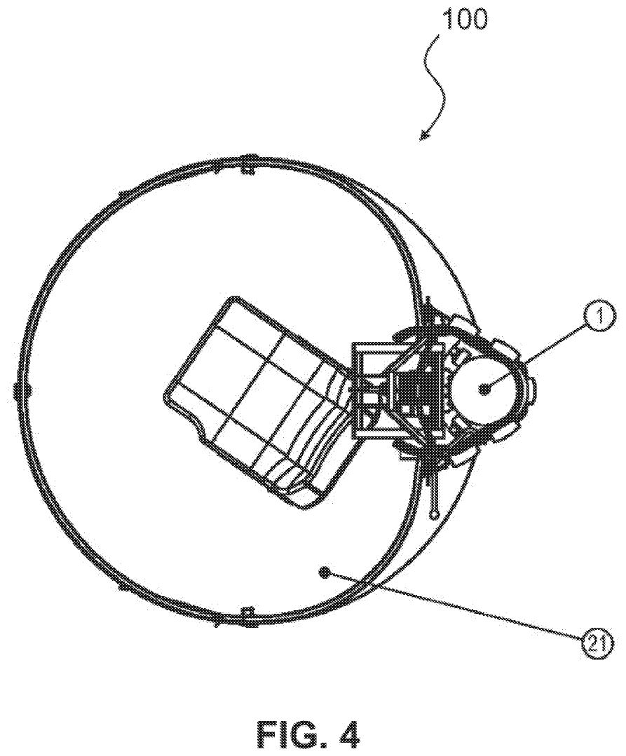

In the illustrated embodiment of FIGS. 1 to 5, the top supporting mechanism 26 comprises a retaining strap 2 configured to surround at least a portion of the vertical structure 1, one or more adjustment locks 3 attached to the retaining strap 2 and a bracket 4.

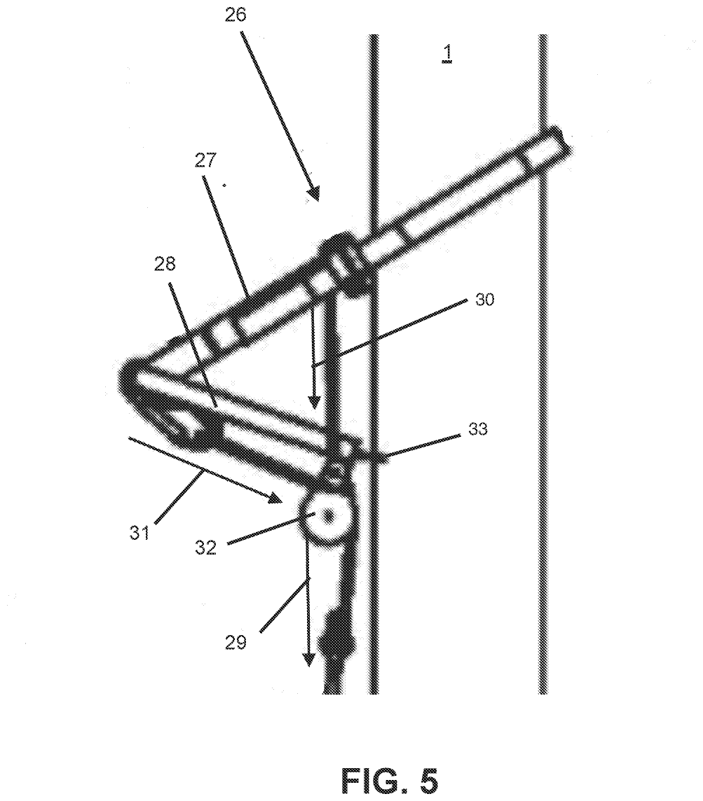

Referring now to FIG. 5, in such embodiment, the bracket comprises an upper chord 27 and a lower chord 28. The upper chord 27 is connected at one end to the adjustment bar 3 and on another end to a second end of the lower chord 28 to form a triangulated structure. The bracket 4 generally aims at providing a cantilever position with respect to the vertical structure 1. In such an embodiment, the cable 6 supporting the platform 21 is connected to the bracket 4 in a manner to transmit the force required to support the self-climbing platform 100 in a generally angled direction 31 to the vertical structure 1 so as to engage the top supporting mechanism 26 with the vertical structure 1 and create a moment about the supporting mechanism 26 generating a pressure on the surface of the vertical structure 1. Such pressure creates a friction force enough to prevent the load and weight of the self-climbing platform 100. In some embodiments, the lower chord 28 comprises a friction member 33 adapted to be pushed against the vertical structure 1 to create the friction force. Indeed, the vertical tension 29 provided by the cable 6 is transmitted at an angle 31 by means of the pulley 32, integral with the upper chord 27 and lower 28 chord, which also applies a downward vertical tension on the connector 26. As such, the top supporting mechanism 26 is thus configured to react vertically as well as at an angle 31 under the tension exerted by the steel cable 6.

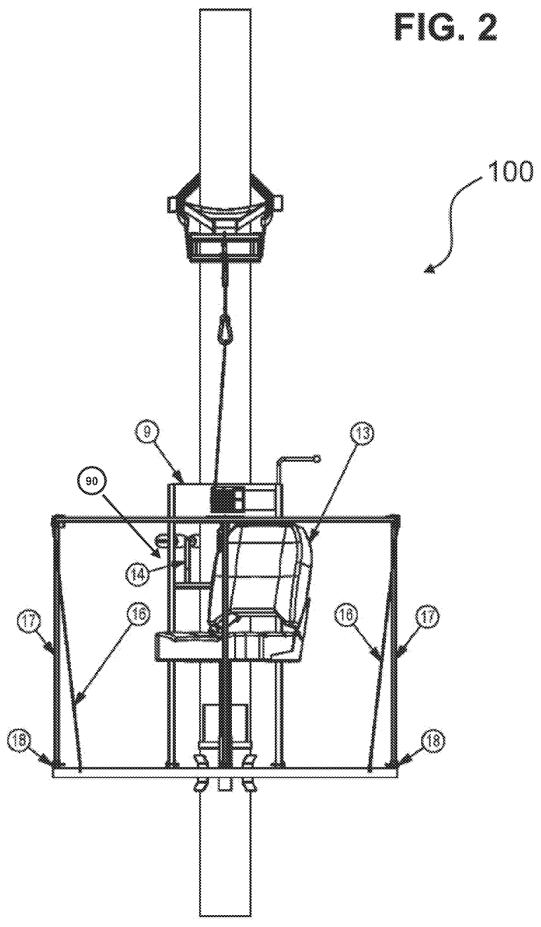

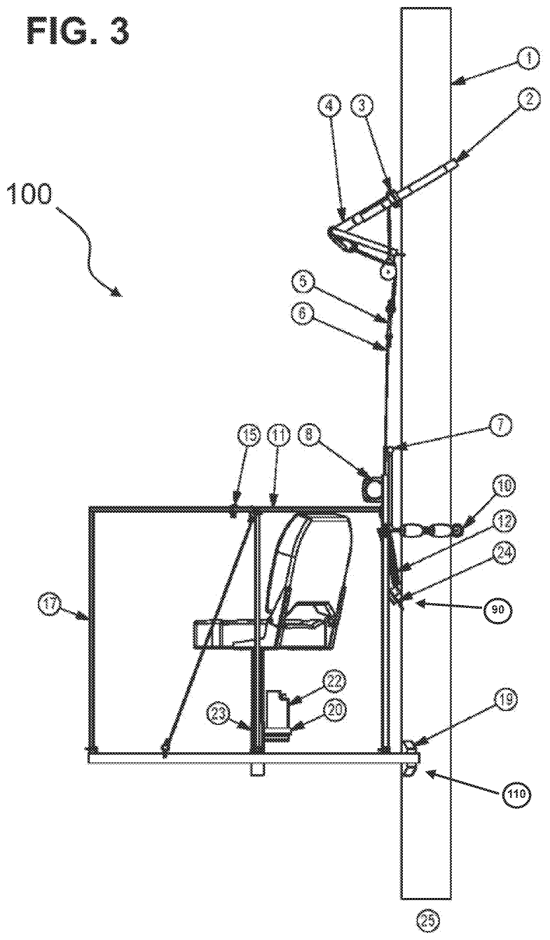

The bracket 4 (shown in FIGS. 2 and 3) may comprise a serrated plate allowing it to remain in the desired position and is fixed to the vertical structure 1 at an angle.

The retaining strap 2 (shown in FIGS. 1 to 3) with adjustment locks 3 makes it possible to manually slide the bracket 4 around the pole or tree 1 over 360° at the desired position, whatever the diameter of the tree or pole. The pressure exerted on the bracket 4 by the platform 21 during the climb generally aims to increase the pressure on the serrated plate and on the bracket 4.

The adjustable retaining strap 2 and the two adjustment locks 3 generally allows the maintenance of the bracket in place on different sizes of poles or trees 1.

Referring again to FIGS. 1 to 3, the main supporting structure 9 comprises a lower supporting mechanism 90 adapted to automatically secure the main support structure 9 about the vertical structure 1 when a load is applied. When the self-climbing platform 100 is supported by the lower supporting mechanism 90, the lower chord 28 may be pushed upwardly to release pressure or the friction force of the top supporting mechanism 26. The said top supporting mechanism 26 may then be moved upwardly or downwardly to continue the vertical movement above or under the current position of the top supporting mechanism 26.

The lifting mechanism 8 is typically embodied as an electric winch configured to operatively engage the cable 6 connected to the top supporting mechanism 26. As illustrated, the cable 6 is connected to the bracket 4 using a carabiner 5. Understandably, any other suitable means known in the art to connect the supporting mechanism 26 to the lifting mechanism 8 maybe used without departing from the scope of the present invention. The load capacity of the lifting mechanism 8 is typically about 2,000 pounds (907 kg).

The lower supporting mechanism 90 is a self-locking adapted to automatically lock downward movement along the vertical structure 1 while allowing upward movement along the same vertical structure 1. In the embodiment illustrated in FIGS. 1 and 3, the lower supporting mechanism 90 comprises a self-locking security lock or supporting member 24 adapted to pivot along a substantially horizontal axis to contact with the vertical structure 1 at an angle. In the illustrated embodiment, the supporting member 24 is pivotally attached to the structure of the lower supporting mechanism 90. In such embodiment, the supporting member 24 is resiliently pushed against the vertical structure. As such, the supporting member 24 may be pivotally attached to the structure using a spring-loaded mechanism 12 or any other means creating a pressure against the vertical structure 1. When pushed against the vertical structure 1, the lower supporting mechanism 90 creates enough friction to support the weight and/or load of the self-climbing platform 100. The lower supporting mechanism 90 may further comprises a handle 7 adapted to momentarily remove the pressure against the vertical structure 1. As such, the handle 7 may be connected to force the pivoting movement of the supporting member 24, such as releasing pressure against the vertical structure 1.

As discussed above, the self-locking security lock 24 may also include a lever or handle 7 and a spring 12 which are connected to the main support for engaging and disengaging the self-locking security system 24 against the vertical structure. The self-locking safety system 24 generally aims at supporting the platform while the tension is removed on the top supporting mechanism 26 during the ascent or descent of the platform 100.

As illustrated, the sliding mechanisms 110 comprises a top sliding or moving system 10 and a lower sliding or moving system 19. The top sliding system 10 may be embodied as wheels pivotally attached to a flexible elongated member adapted to be installed around the vertical structure 1. In such an embodiment, the top sliding system 10 may be adjusted to the circumference of the vertical structure 1, as such circumference may vary while the platform 100 move along the said structure 1. The lower sliding system 19 may be embodied as skis or sliders attached to the support platform 21. In a typical embodiment, the sliders or skis are made of low-friction material, such as polymers or plastics.

In other embodiments, the upper 10 or lower 19 sliding systems are integrated with the platform 21 and facilitate the sliding of the platform on the vertical structure 1.

The platform 21 is typically connected or fixed to the main supporting structure 9. As discussed above, the lifting mechanism 8 and lower supporting mechanism 90 are generally installed and operatively connected to the cable 6.

In certain embodiments, the self-climbing platform 100 may also include a removable seat 13, and/or a removable safety railing 11, and/or a battery 22, and/or a cover.

In some embodiments, the removable seat 13 may be rotatable, as being adapted to rotate 360°. The seat is typically received by a support 23 fixed to the supporting platform 21. The platform 100 generally provides the user with a freedom of movement of 360° either standing or sitting.

In certain embodiments, the safety railing 11 may be lockable, such as by using a security lock 15 and/or may be removable. In some embodiments, the safety railing 11 is connected to the platform 21 using three railing supports 17 and two stabilizing cables 16. The railing supports 17 and the stabilizing cables 16 are connected to the safety railing 11. Anchoring locks 18 can also keep the railing supports 17 in place. The railing supports 17 may generally improve safety so as to prevent falls of a user from the platform 100.

The self-climbing platform 100 may also include a battery 22. The battery 22 is typically powers the lifting mechanism 8. In some embodiments, the battery 22 is a 12 volts battery and is installed on a support 20 attached above the platform 21. Understandably, the battery 22 may be installed anywhere on the self-climbing platform 100. In embodiments having a seat 13, the battery 22 may be installed below the seat 13. The support 20 can be connected to the support of the seat 23. Of course, the platform 100 can be powered by any other sources of currents, such as solar energy with the use of a solar panel. In some embodiments, the platform may include one or more power outlets, such as USB jacks.

In other embodiments, the platform 100 may be provided with a cover or canvas to position above the user of the platform 100, for example installed as an umbrella facing the weather. The cover can also be installed to surround the platform to protect the user and/or equipment.

The self-climbing platform 100 can be removable and transportable. The platform 100 can also be made of rigid materials, such as metal, aluminum, steel or other types of alloys. In general, the platform 100 is lightweight, removable and low volume. The platform 100 can also be used by people with reduced mobility.

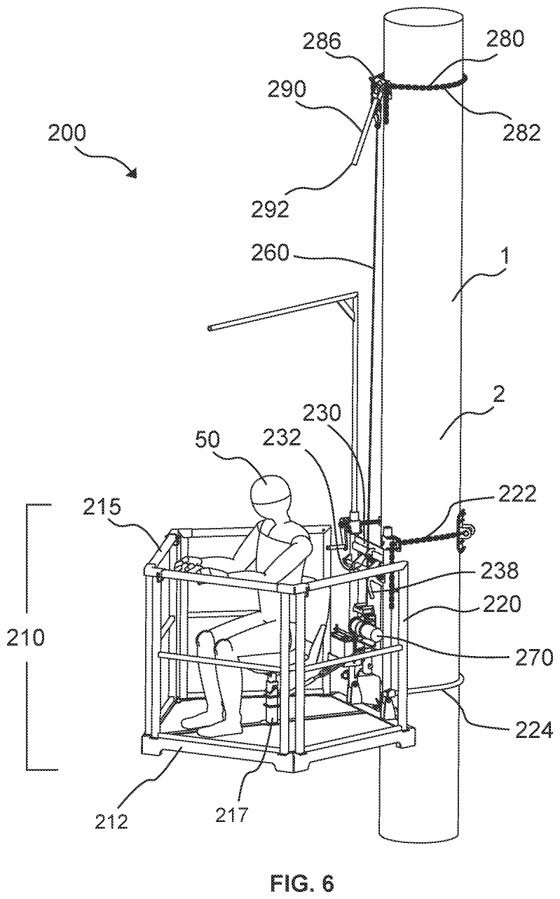

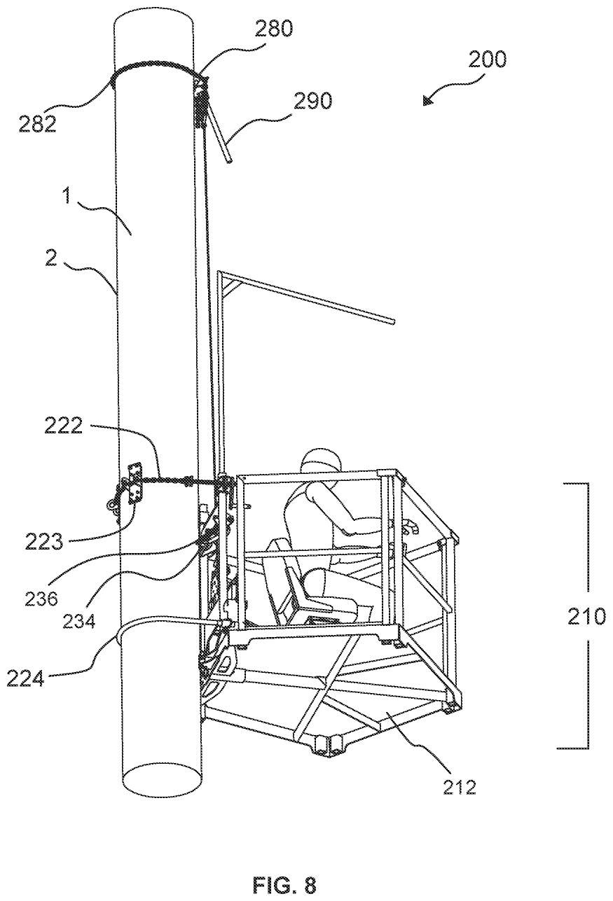

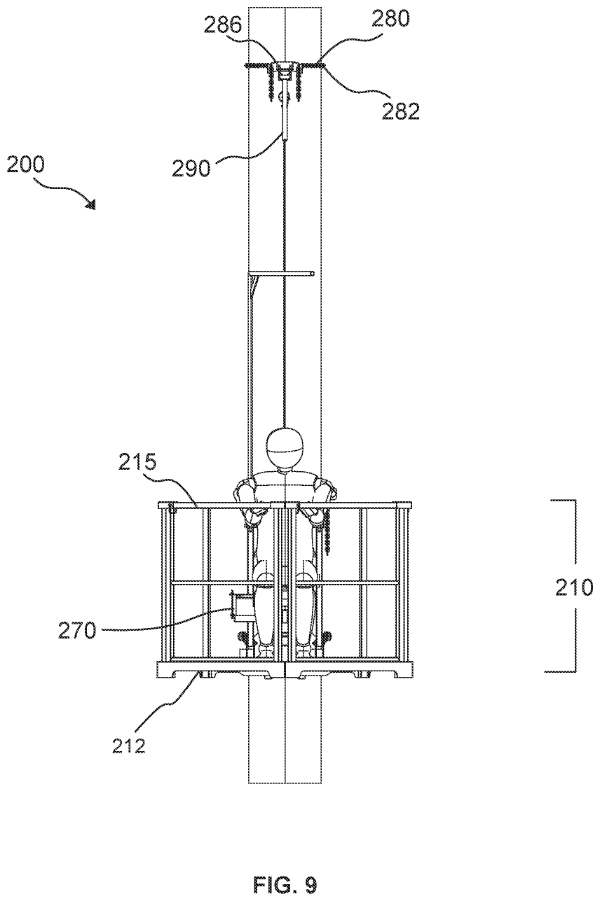

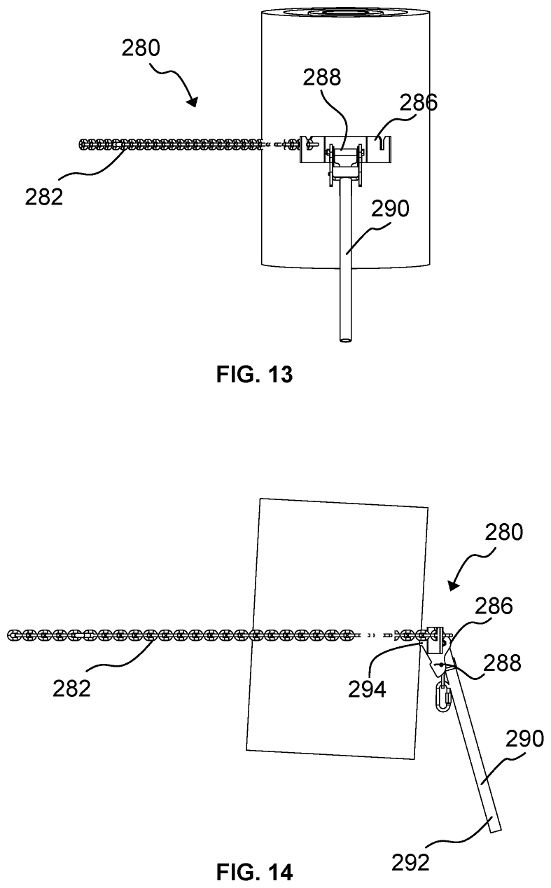

Referring now to FIGS. 6 to 14, a second embodiment of a self-climbing platform 200 is illustrated. The self-climbing platform 200 is similarly adapted to be sequentially supported by various securing means to allow an ascent of the self-climbing platform 200 up the vertical structure 1. Broadly, the self-climbing platform 200 comprises a support platform 210, an upper locking support 280 configured to be alternatively secured to the vertical structure 1, a lower self-locking support system 230, a lifting device 270 and a suspending device 260 to hold in tension the support platform 210 from the upper locking support 280. The self-climbing platform 200 may selectively ascend or descend the said vertical structure 1 by alternatively securing/releasing attachment of the upper locking support 280 to the vertical structure 1 while the said platform 200 is supported by the lower self-locking support system 230.

The support platform 210 is generally configured to support a user 50. In certain embodiments, the support platform 210 comprises a support base 212 providing a substantially flat surface for supporting the user 50 and/or equipment (not shown). The support platform 210 may further comprise a railing or barrier 215 to prevent an accidental or undesired fall from the support base 212. The support platform 210 may similarly comprise a seat 217 adapted to support the user 50 in a seated position.

Referring to FIGS. 6 to 10, the support platform 210 further comprises a frame 220 secured to the support base 212 and structurally capable of supporting the weight of the support platform 210 and its load. The frame 220 is slidingly secured to the vertical structure 1 by first and second sliding systems 222, 224, such as an upper sliding system 222 and a lower sliding system 224. The sliding or gliding systems 222, 224 being secured to the frame 220 at both ends. The first and second support sliding systems 222, 224 may be embodied as straps and/or may comprise a chain or any other suitable flexible material for being tensioned against the vertical structure 1 while allowing a desirable degree of slippage between the frame 220 and the vertical structure 1. Understandably, the self-climbing platform 200 may comprise any suitable number of support straps. It may be appreciated that the use of at least two support sliding systems 222, 224 may assist in laterally securing the self-climbing platform 200 to the vertical structure 1 to prevent an undesirable pivoting of the self-climbing platform 200 about the first sliding system 222.

In a preferred embodiment, the first and second sliding systems 222, 224 have a length suitable for wrapping around the vertical structure 1. In a preferred embodiment, the length of the first and second sliding systems 222, 224 is variable to adapt to varying circumference along the height of the vertical structure 1. For example, when the vertical structure 1 is a tree, cross-sectional area and therefore the circumference of the vertical structure 1 may decrease in height therefore requiring a shorter length of the first and second sliding systems 222, 224. To that end, the self-climbing platform 200 may comprise a crank 226 adapted to engage one or more of the first and second sliding systems 222, 224, such as straps, to adjust their lengths.

The sliding systems 222, 224 may further limit lateral movement of the self-climbing platform 200 while allowing vertical displacement of the frame 220 about the vertical structure 1. In certain embodiments and referring to FIG. 8, the first support strap 222 is a chain comprising one or more glide plates 223 having a substantially smooth and low friction surface (not shown) in contact with an outer surface 2 of the vertical structure 1 to further facilitate the vertical displacement of the first sliding system 222 about the vertical structure 1.

The frame 220 further comprises a self-locking support system 230 adapted to automatically secure the support platform 210 about the vertical structure 1 when a load is applied. In particular, the self-locking support system 230 may allow an unrestricted ascent of the self-climbing platform 200 while automatically preventing an undesirable descent of said support platform 210. To that end, the self-locking support system 230 may comprise a brace 232 configured to be pressed against the surface of the vertical structure 1 to secure the support platform 210 to the vertical structure 1 as described in greater details below. In a preferred embodiment, the brace 232 comprises a gripping or friction member 234, such as a serrated edge (shown in FIG. 8) in contact with the outer surface 2 of the vertical structure 1 to further grip said outer surface 2.

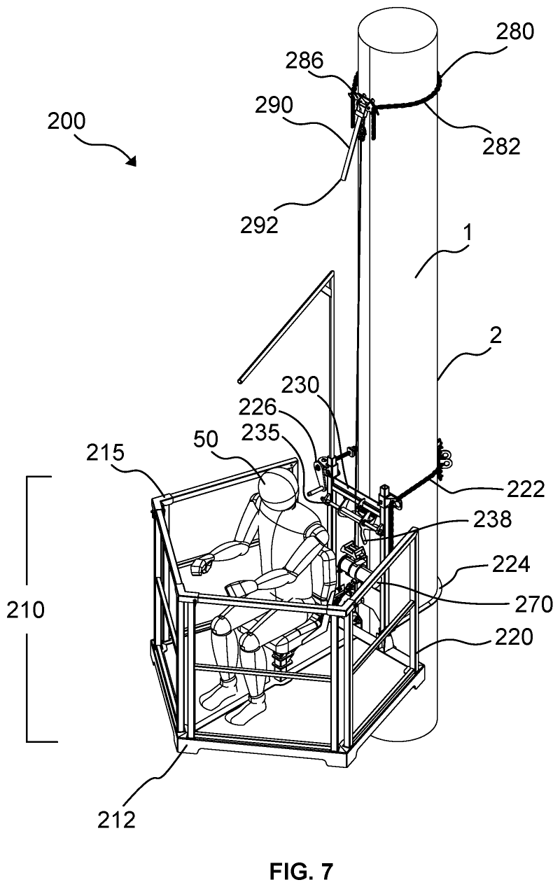

Referring now to FIG. 7, the self-locking support system 230 further comprises a horizontal shaft 235 secured to the frame 220 for pivotally securing the brace 232 to the frame 220. In certain embodiments, the brace 232 pivots about the horizontal shaft 235 and extends downwardly at an angle from said horizontal shaft 235 towards the outer surface 2 of the vertical structure 1. The self-locking support system 230 further comprises a resilient or pushing element 236 adapted to pivot the brace 232 upwardly towards vertical structure 1 thereby further pressing the brace 232 against the vertical structure 1. The resilient element 236 may be a spring-loaded member or any other suitable mechanism for resiliently providing a force to brace 232. As the friction member 234 of the brace 232 is angled downwards and pressed against the outer surface 2 of the vertical structure 1, the weight of the support platform 210 and its load pushes the friction member edge 234 into or toward said outer surface 2. In use, the self-locking support system 230 is therefore configured to default the brace 232 towards the vertical structure 1 thereby automatically securing the self-climbing platform 200 to said vertical structure 1 as the support platform is pushed downwards under its own weight.

It may be appreciated that the geometry of the self-locking support system 230 may allow an unrestricted ascent of the support platform 210. Notably, the angle of the brace 232 may allow the vertical structure 1 to slide downwardly relative to said brace 232 without the friction member 234 being pushed into the outer surface 2 of the vertical structure 1. Indeed, as the platform 200 is moved up, the friction member 234 slides on the outside surface 2 of the vertical structure 1. When movement is stopped and tension is revered on the self-locking support system 230, the friction member 234 is automatically pushed against the vertical structure 1. To that end, the self-locking support system 230 may allow an ascent of the support platform 210 while automatically preventing an undesired descent.

Referring again to FIGS. 6 and 7, the self-locking support system 230 may comprise a lever 238 allowing the user 50 to selectively pivot the brace 232 away from or toward the vertical structure 1. When moved away, the self-locking support system 230 is released from the vertical structure 1 to allow a downward or upward vertical displacement of the self-climbing platform 200.

Referring again to FIGS. 6 to 10, the self-climbing platform 200 comprises a suspending device 260, such as suspension cable 260. The suspending device 260 comprises a first end 262 attached to the frame 220 and a second end 264 attached to an upper locking support 280. The suspending device 260 may be attached to the frame 220 and to the upper locking support 280 using any of known means such as, for example, a carabiner 265. In certain embodiments, the first end 262 may be attached to a lifting device 270 affixed to the support platform 210. The lifting device 270 may comprise a winch or any other suitable device. The lifting device 270 may be motorized, such as with an electric motor powered by a power source such as a battery, a solar panel or other transportable power source.

The upper locking support 280 comprises a securing member 282, such as but not limited to a chain, strap or flexible member adapted to be put in tension, configured to surround at least a portion of the vertical structure 1. The securing member 282 frictionally engages the outer surface 2 of the vertical structure 1 and secures the upper locking support 280 to the vertical structure 1. The securing member 282 may comprise a chain or any other suitable flexible material for being tensioned and gripping the vertical structure 1. In a preferred embodiment, the upper locking support 280 is adapted to be secured to the vertical structure 1 while supporting the weight of the support platform 210.

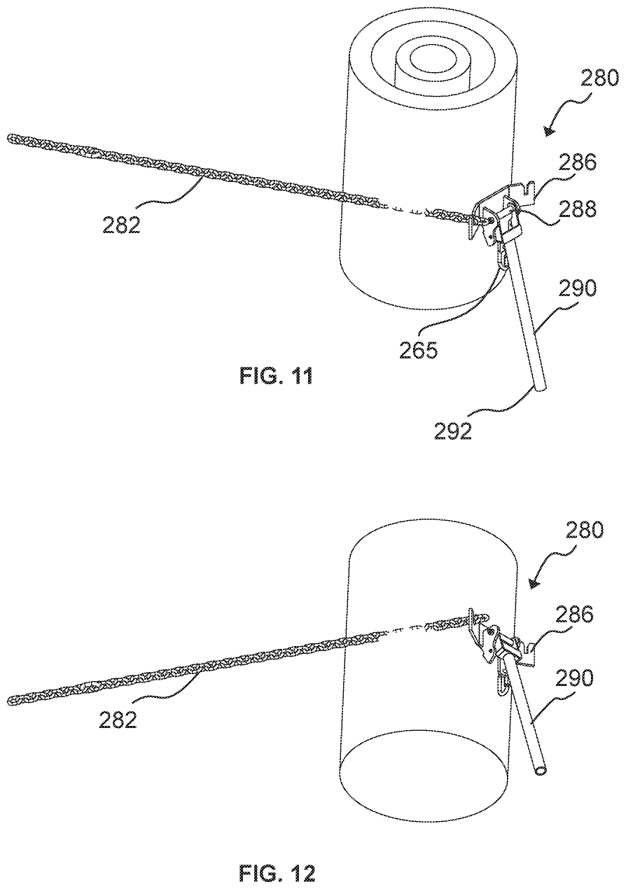

Referring to FIGS. 11 to 14, the upper locking support 280 may further comprise an attachment bracket 286 adapted to receive and secure the securing member 282 at both ends of said securing member 282. The upper locking support 280 may further comprise a quick release lever 290 pivotally attached to said attachment bracket 286 about a fulcrum 288 to selectively tighten and untighten the securing member 282. In some embodiments, the quick release lever 290 may comprise a handle 292 and a pivot portion 294 (shown in FIG. 14) extending opposite the handle 292 and pivoting about the fulcrum 288 to press against the outer surface 2 of the vertical structure 1 and push said attachment bracket 286 away from the outer surface 2. When the lever 290 is pivoted upwardly, the tension is reduced in the securing member 282 and when the lever 290 is pivoted downwardly, the tension is increased in the securing member 282 and the attachment bracket 286 is frictionally engaged with the outer surface 2 of the vertical structure 1. As such, the attachment bracket 286 may comprise an edge or friction member adapted to create a friction about the outside surface 2 of the vertical structure 1.

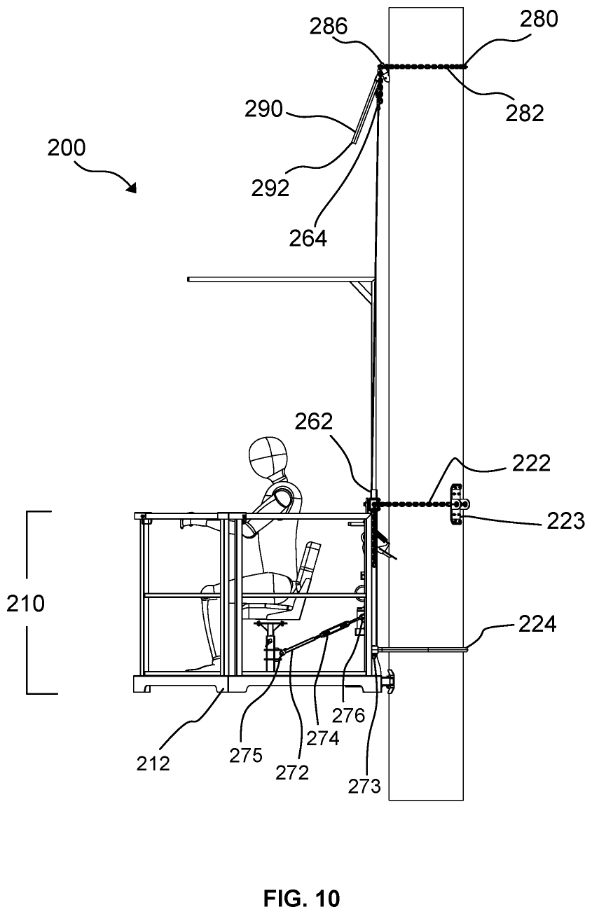

According to certain embodiments and referring to FIG. 10, the self-climbing platform 200 further comprises a pivoting mechanism 272 adapted to pivot the support base 212 about a pivoting axis 273 allowing the user 50 to adjust the angle of the support base 212 when ascending or descending an angled vertical structure 1. In particular, the pivoting mechanism 272 may allow the support base 212 to remain horizontal or level with the ground. The pivoting mechanism 272 may comprise a cable or rod 274 being adjustable in length and comprising a first end 275 affixed to the base 212 or the seat 217, and a second end 276 affixed to the frame 220. In such embodiments, the support base 212 may be secured to the frame 220 exclusively about the pivoting axis 273 such that an adjustment of the length of the rod 274 will cause the support base 212 to pivot about the pivoting axis 273. In some embodiments, the rod 274 may comprise two threaded portions cooperatively engaged to adjust a length the length of the rod 274 when they are rotated with respect to one another. Understandably, any other suitable mechanism for adjusting the length of a rod or a cable may be used without departing from the scope of the invention such as, for example, a winch. In certain embodiments, the pivoting mechanism 272 may allow the pivoting base 212 to pivot about 20° about the pivoting axis 273.

In certain embodiments, the suspending device 260 is attached to the attachment bracket 286 at a point near the outer surface 2 of the vertical structure 1 to minimize the moment generated about the securing strap 2 by the suspending device 260 when in tension.

Assembly and operation

The components of the self-climbing platform 100/200 can be transported in transport bags or on a coupling of a small motorized vehicle. The platform 100/200 can be manufactured in such a way that the assembly and disassembly of the components of the platform 100/200 are carried out without any tools and/or in a simple manner.

The self-climbing platform 100/200 can be assembled according to the following steps: connect the platform 21 to the main support 9, connect the removable safety railing 11 and the railing supports 17 to the platform, and connect the steel cable 6 of the winch 8 to the carabiner 5 of the bracket 4.

Once the self-climbing platform 100/200 assembled, a user can access the platform 100/200 without the help of a ladder. The platform 100 can support high load at this time. The height at which the self-climbing platform 100/200 can be raised is adjustable according to the length of the suspending device 6/260 of the lifting device 8/270 and the quality of the anchoring, that is to say the quality of the vertical structure 1.

Once the self-climbing platform 100 is brought near the tree or the vertical structure 1, the upper supporting system 26/280 is installed or anchored on the tree or vertical structure 1 at the desired location, the height of the user. Once the upper supporting system 26/280 is installed to support the weight of the self-climbing platform 100/200, the user can perform an action of ascent or descent.

The user can then activate the lifting system 8/270 to hoist the self-climbing platform 100/200 on the tree or vertical structure 1. The ascent and descent are performed safely while being guided by the sliding systems 10, 19, 222 or 224. The adjustable support wheels 10 are adjusted according to the diameter of the tree or vertical structure 1.

During the ascent of the self-climbing platform 100/200, the platform 100/200 rises until it is stopped by the user of the winch 8, the elevation being limited by the height of the upper supporting system 26/280 on the tree or the vertical structure 1. The movement is done using a winder-unwinder tensioner with a retaining strap, which passes through the adjustable support wheels 10, which aims to provide a stable and safe movement.

When stopping the self-climbing platform 100/200, the self-locking safety lock 24, 230 is automatically deployed. The self-locking lock 24, 230 generally makes it possible to maintain the self-climbing platform 100 in the desired position on the vertical structure 1.

During the descent of the platform 100, a double maneuver to initiate the descent can be performed for embodiments having a lever 14. The user must simultaneously activate the lever 14 of the self-locking security lock 24, 230 and activate the winch 8 to unwind the steel cable 6 to start the descent. The user shall stop the descent to lower the top supporting mechanism 26, 280 while the platform 100, 200 is supported by the lower self-locking device 24, 230. When the top supporting mechanism 26, 280 is lowered, the user may continue the descent and repeat the previous steps until the platform 100, 200 reaches the ground or a desired height.

Referring again to FIGS. 6 to 14, an operation of the self-climbing platform 200 is illustrated. During ascent of the self-climbing platform 200, the upper locking support 280 may be secured to the vertical structure 1 at a desirable height above the support platform 210 being reachable by the user 50. Once said upper locking support 280 is secured by locking the quick release lever 290, the lifting device 270 may be activated to pull the suspending device 260 and ascend the support platform 210 upwards.

In a subsequent step and once the support platform 210 has reached a desired height or an upper limit defined by the position of the upper locking support 280, the quick release lever 290 may be released to unlock the upper locking support 280. Accordingly, the support platform 210 may no longer be suspended by the suspending device 260 as the self-locking support system 230 is engaged with the outer surface 2 of the vertical structure 1 to secure and support the support platform 210 to said vertical structure 1. The above specified process may be repeated if the user 50 elects to ascend the vertical structure 1 even higher.

During descent of the self-climbing platform 200, the upper locking support 280 may similarly be secured to the vertical structure 1 at a desirable height above the support platform 210 being reachable by the user 50 and preferably at a height near an upper edge of the support platform 210. Once said upper locking support 280 is secured by locking the quick release lever 290, the motorized lifting device 270 may be activated to once again pull the suspending device 260 sufficiently to place said suspending device 260 under tension.

In a subsequent step, the release lever 238 may be released to unlock the self-locking support system 230 thereby transferring the weight or some of the weight of the support platform 210 onto the suspension cable 260. The self-climbing platform 200 may thereafter be lowered by activating the motorized lifting device 270 in a reverse direction to release the suspending device 260 and increase the length of said suspending device 260. During the descent, the user must keep the self-locking support system 230 unlocked to allow the platform 100, 200 to downwardly slide along the vertical structure 1.

Once the support platform 210 has reached a lower limit defined by the ground or a point whereby the upper locking support 280 is at a limit of the reach of the user 50, the process may be repeated to once again further lower the support platform 210.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A self-climbing platform adapted to movably attach to a substantially cylindrical and vertical structure, the self-climbing platform comprising:
a platform forming a surface for supporting a load, the platform being adapted to hang from the vertical structure above ground
an upper locking support comprising:
a retaining member configured to surround at least an outer portion of the vertical structure and to frictionally engage with the outer portion of the vertical structure;
a bracket configured to receive first and second ends of the retaining member; and
a first locking mechanism for selectively tensioning and releasing tension in the retaining member to the vertical structure;
wherein the upper locking support selectively restricts downward movement of the platform along the structure and is movable vertically when tension is released on the upper locking support;
a lower self-locking support system suspended to the upper locking support, the lower self-locking support automatically supporting the vertical load of the platform and restricting downward movement of the platform along the structure while allowing an upward movement along the structure.

2. The self-climbing platform of claim 1, the main support being suspended from the bracket by a cable.

3. The self-climbing platform of claim 2, wherein the cable is connected to the bracket by a bearing element.

4. The self-climbing platform of claim 2, wherein the platform further comprises a winch connected to the cable, the winch being adapted to lift and descend the platform when the upper locking support is engaged with the vertical structure.

5. The self-climbing platform of one of claim 1, wherein the platform comprises at least one sliding system to slide along the vertical structure.

6. The self-climbing platform of claim 5, wherein the sliding system is configured to slide around the vertical structure and allow rotation of the platform around the vertical structure while suspended.

7. The self-climbing platform of one of claim 1, wherein the lower self-locking locking support system comprises a lever for temporarily disengaging the lower self-locking locking mechanism.

8. The self-climbing platform of claim 7, wherein the lever is biased by a resilient member to maintain the lower self-locking support system against the structure.

9. The self-climbing platform of claim 8, the resilient member being a spring.

10. The self-climbing platform of claim 1, wherein the upper locking support comprises a quick release lever.

11. The self-climbing platform of claim 1 further comprising a pivoting mechanism adapted to pivot the platform about an axis substantially orthogonal to a longitudinal axis of the vertical structure, the pivoting mechanism comprising a telescopic rod.

12. A method of vertically moving a platform about a substantially cylindrical and vertical structure comprising:
continuously restricting a downward movement of the platform along the vertical structure;
securing an upper locking support to the vertical structure above the platform at a first location; and
lifting the vertical structure while the downward movement of the platform is continuously restricted.

13. The method of claim 12 further comprising releasing tension on the upper locking support while the downward movement of the platform is continuously restricted.

14. The method of claim of claim 13 further comprising securing the upper locking support to the vertical structure at a second location above the first location and ascending the vertical structure near the second location.

15. The method of claim 12 wherein lifting the vertical structure comprises actuating a motorized lifting device.

16. The method of claim 12 further comprising using a release lever of a self-locking support mechanism to release tension of the self-locking support mechanism while the upper locking support is secured.

17. The method of claim 12 wherein securing the upper locking support comprises engaging a quick release lever.

18. A method of vertically descending a platform about a substantially cylindrical and vertical structure comprising:
securing an upper locking support to the vertical structure above the platform at a first location;
releasing a self-locking support mechanism adapted to restrict a downward movement of the platform along the vertical structure; and
descending the vertical structure while the downward movement of the platform is continuously unrestricted.

19. The method of claim 18 further comprising actuating a motorized lifting device to tension a suspending device prior to releasing the self-locking support mechanism.

20. The method of claim 18 further comprising:
reengaging the self-locking support mechanism;
releasing the upper locking support from the vertical structure; and
repositioning the upper locking support at a second location being lower than the first location.

21. The method of claim 18, wherein releasing the self-locking support mechanism comprises engaging a release lever of the self-locking support mechanism.
